(19) United States
(12) Patent Application Publication
(10) Pub. No.: US 2012/0200144 A1
(43) Pub. Date: Aug. 9, 2012

(54) Brilliant Etched Wheels

(76) Inventor: Francisco J. Hodges, Yorba Linda, CA (US)

(21) Appl. No.: 13/367,331

(22) Filed: Feb. 6, 2012

Related U.S. Application Data
(60) Provisional application No. 61/439,813, filed on Feb. 4, 2011.

(51) Int. Cl. B60B 1/00

(52) U.S. Cl. 301/104

(57) ABSTRACT

The invention comprises a wheel with improved cooling characteristics and method of making a wheel with a high efficient heat exchange capability. The edges of the wheel being modified to increase surface area while maintaining performance and aesthetics.

### CROSS-REFERENCE TO RELATED APPLICATION

U.S. provisional application No. 61/439,813 dated Feb. 4, 2011 the contents of which are hereby incorporated by reference.

### BACKGROUND OF THE INVENTION

The present invention relates in general to automotive wheels and in particular to wheel designs intended to remove heat from a tire to maintain predetermined performance characteristics.

Changes to tire temperature can adversely affect tire performance for example; increased tire temperature will increase the tire pressure (ideal gas law) which can cause under-steer in front tires and over-steer from the rear tires. Several methods for cooling or maintaining consistent tire temperatures have been used over the past fifty years. U.S. Pat. No. 3,921,688 titled, “SELF-COOLING TIRE” discloses two different metal implants in the tire with high thermal conductivity that an electric current is applied to aid in the dissipation of heat from the tire during normal operation. U.S. Pat. No. 4,343,338 titled, “TIRE COOLING SYSTEM AND METHOD” discloses a tire that circulates a fluid through a heat exchange system disposed external to the tire to dissipate heat from heavy equipment tires. U.S. Pat. No. 4,480,669 titled, “TIRE COOLING STRUCTURE” discloses a tire insert that takes advantage of the forces applied to a tire during operation to effectively pump the air inside the tire to increase air movement across the metal rim and dissipate heat. The above referenced patents and patent applications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

Although various aids are known to the art, all, or almost all of them suffer from one or more than one disadvantage. Therefore, there is a need to provide an improved tire cooling system.

### SUMMARY OF THE INVENTION

The present invention relates in general to a method of making and using a wheel that improves cooling of a tire. The wheel is etched along the surface in the axial direction to increase surface area and create nodes. The nodes have a high zenith and low nadir that can be repeated along the entire spoke of a wheel. The nodes can be oriented orthogonal or parallel to the direction of travel. The nodes increase the surface area of the wheel and create turbulence in the air flow over the wheel allowing the wheel to efficiently dissipate heat from the tire during normal operation. The increased cooling efficiency will improve tire performance, tire wear, and tire life.

It is to be understood that the foregoing general description and the following detailed description are exemplary and explanatory only and are not to be viewed as being restrictive of the present invention, as claimed. Further advantages of this invention will be apparent after a review of the following detailed description of the disclosed embodiments which are illustrated schematically in the accompanying drawings and in the appended claims.

### BRIEF DESCRIPTION OF THE FIGURES

In the following, embodiments of the present invention will be explained in detail on the basis of the drawings, in which:

FIG. 1 is a diagram of a wheel with the brilliant etch.

FIG. 2 is a diagram of a series of nodes in a preferred embodiment.

FIG. 3 is a diagram of a single node of a preferred embodiment.

FIG. 4 is a photograph of a preferred embodiment of the etching on a wheel.

### DETAILED DESCRIPTION

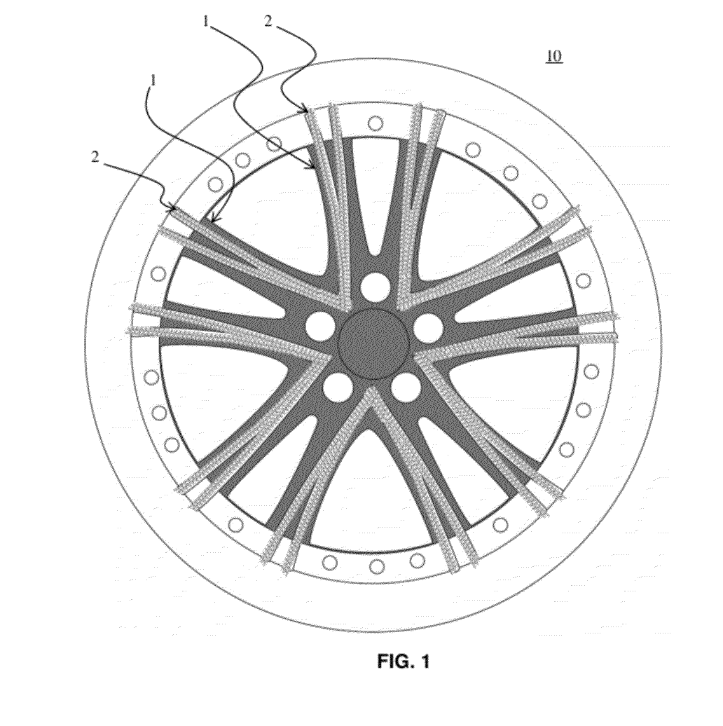

FIG. 1 shows a preferred embodiment wherein a wheel 10 has ten spokes 1 and each spoke 1 has two edges 2 that are etched with nodes 5 in the radial direction. In particular the nodes 5 are generally in linear and uniform distribution. But the nodes 5 can be distributed in an irregular or uneven pattern.

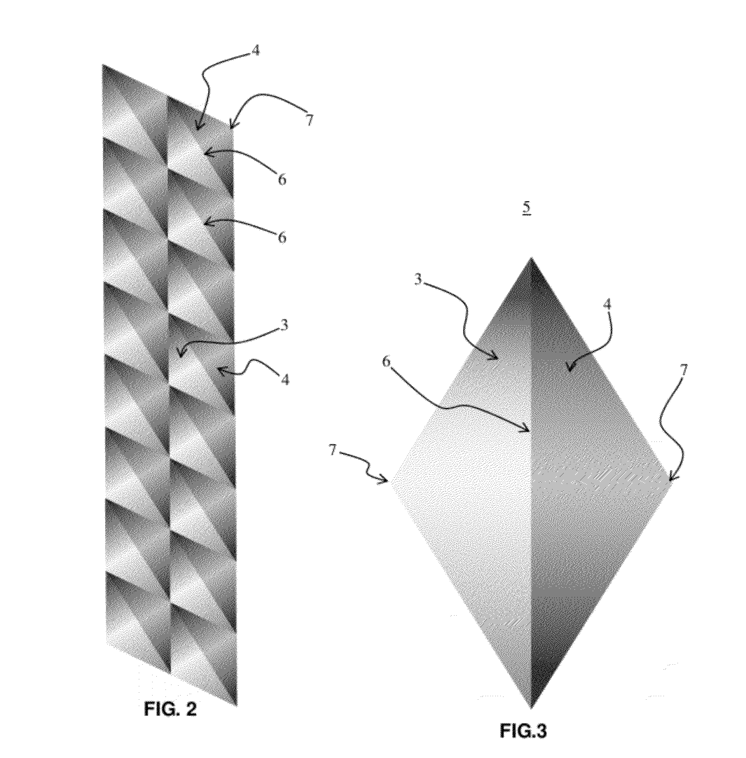

FIG. 2 illustrates a series of nodes 5 that are diamond shaped in two rows adjacent each other. The rows could be aligned for the nodes 5 to be parallel or off set depending on the shape of the node. For example, in FIG. 3 a single node 5 is shown comprising two surfaces 3,4 each having three sides forming a triangle and having a common side 6 thus forming a diamond or rectangular shape. In FIG. 3, the zenith of the node 5 is along the common side 6 of each triangle while the nadir is at the vertex 7 of the triangles sharing a common side 6. The surfaces 3,4 of the node 5 is flat in the preferred embodiment, however, the surfaces 3, 4 may be textured to further increase surface area. The surface flatness will be determined by the method used to machine or etch the surfaces 3, 4. Alternatively, nodes 5 could have many more sides to accommodate different wheel designs or spoke designs. Further, nodes 5 do not have to be limited to straight edged shapes such as rectangles in FIG. 3, the nodes 5 could be dimpled similar to the surface on a golf ball or have round, oval or generally circular shapes so long as the node 5 has a zenith and nadir. In the case of a node 5 with round, oval, or generally circular shape the surface could convex or concave.

Node 5 length and width can vary depending on the shape of the spoke or surface area required to obtain efficient cooling.

Node depths, the difference between the zenith and nadir, in the preferred embodiment is uniform. The depth of the node 5 that can effectively cool the wheel 10 will depend on the shape of the spoke 1 and total surface area etched, but generally, node depths of 0.1 millimeter and up to 10 millimeters will be efficient. In the preferred embodiment the node depth is about one millimeter.

Node orientation can be at any angle because the relative forward motion of vehicle travel will exceed any angular velocity experienced along the surface of the wheel 10, therefore air will flow over the nodes 5 at any vehicle speed.

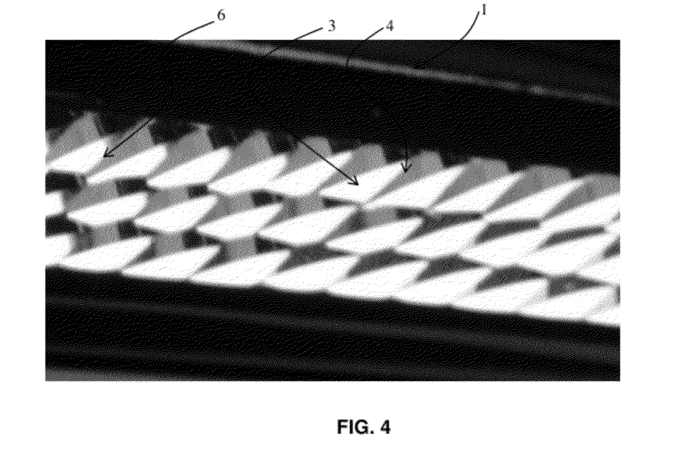

FIG. 4 is a photograph a preferred embodiment where an aluminum wheel has three rows of diamond shaped nodes 5 etched in a linear manner along the edge of a spoke 1. The width of the nodes 5 is approximately three millimeters along the common side 6 that forms the zenith and the depth of the node 5 is approximately one millimeter.

The foregoing description is, at present, considered to be the preferred embodiments of the present discovery. However, it is contemplated that various changes and modifications apparent to those skilled in the art, may be made without departing from the present discovery. Therefore, the foregoing description is intended to cover all such changes and modifications encompassed within the spirit and scope of the present discovery, including all equivalent aspects.

What is claimed is,:

1. A wheel having spokes that are etched to create a cooling surface.

2. The wheel of claim 1, wherein the spokes are etched along an edge of the spoke.

3. A wheel having spokes that are etched to create a multiplicity of nodes.

4. The wheel of claim 3, wherein the nodes are diamond in shape.

5. The wheel of claim 3, wherein the node depth is between 0.1 and 10 millimeters.
